(19) United States
(12) Patent Application Publication
(10) Pub. No.: US 2025/0355167 A1
(43) Pub. Date: Nov. 20, 2025

(54) DIRECT BONDING USING LOW INDEX FILM AND LAMINATION FOR WAVEGUIDE

(71) Applicant: Applied Materials, Inc., Santa Clara, CA (US)

(72) Inventors: Yingdong LUO, Newark, CA (US); Jinyu LU, Santa Clara, CA (US); Marco GALIAZZO, Olmi di San Biagio di Callalta (IT); Young Moon LEE, Santa Clara, CA (US); Xiaopei DENG, San Jose, CA (US); Neal RICKS, San Jose, CA (US); Kangkang WANG, San Jose, CA (US); Rami HOURANI, Santa Clara, CA (US); Ludovic GODET, Sunnyvale, CA (US); Evan WANG, Palo Alto, CA (US)

(21) Appl. No.: 19/182,549

(22) Filed: Apr. 17, 2025

Related U.S. Application Data
(60) Provisional application No. 63/636,979, filed on Apr. 22, 2024.

(51) Int. Cl. G02B 6/12; G02B 1/11; G02B 1/14; G02B 6/122; G02B 6/13

(52) U.S. Cl. CPC G02B 6/12004; G02B 1/11; G02B 1/14; G02B 6/1223; G02B 6/13; G02B 2006/12102; G02B 2006/12107

(57) ABSTRACT

Embodiments of the present invention relate to waveguide and methods of forming waveguides. The waveguide includes a waveguide stack including a waveguide substrate having a top surface and a bottom surface, a first low index layer disposed on the top surface, a first cap layer disposed on the first low index layer, a first lens disposed on the first cap layer, and a first optically clear adhesive layer between the first low index layer and the first lens. In another embodiment, a method of forming a waveguide is provided. The method includes dispensing a liquid optically clear adhesive layer on a lens, placing a waveguide stack including a first low index layer onto the liquid optically clear adhesive opposite the lens, and curing the liquid optically clear adhesive. The waveguide stack further includes a first cap layer disposed on the first low index layer.

### CROSS-REFERENCE TO RELATED APPLICATIONS

This application claims the benefit of U.S. Provisional Patent Application Ser. No. 63/636,979, filed Apr. 22, 2024, which is incorporated by reference herein in its entirety.

### BACKGROUND

### Field

Embodiments of the present disclosure generally relate to waveguide combiners. More specifically, embodiments described herein provide for methods of forming waveguide combiners.

### Description of the Related Art

Virtual reality is generally considered to be a computer generated simulated environment in which a user has an apparent physical presence. A virtual reality experience can be three-dimensionally generated and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhance or augment the environment that the user experiences. Image sharpness of the virtual image may be affected by the environment.

One challenge is displaying a virtual image overlaid on an ambient environment. Waveguide combiners, such as augmented reality waveguide combiners, are used to assist in overlaying images. Generated light is propagated through a waveguide combiner until the light exits the waveguide combiner and is overlaid on the ambient environment. To do so, the generated light needs to undergo total internal reflection (TIR). Waveguide combiners may use a low index film to promote TIR within the waveguide combiner. However, these low index films may be porous and susceptible to alteration by the material of other layers that contact the low index films, impacting the overall performance of the waveguide combiner.

Accordingly, there is a need for improvements to augmented reality technology.

### SUMMARY

Embodiments of the present disclosure generally relate to waveguide combiners. More specifically, the present disclosure relates to methods of forming waveguide combiners.

In an embodiment, a waveguide is provided. The waveguide includes a waveguide stack including a waveguide substrate having a top surface and a bottom surface, a first low index layer disposed on the top surface, a first cap layer disposed on the first low index layer, a first lens disposed on the first cap layer, and a first optically clear adhesive layer between the first low index layer and the first lens.

In another embodiment, a waveguide is provided. The waveguide includes a waveguide stack including a waveguide substrate having a top surface and a bottom surface, a first low index layer disposed on the top sur face, a first cap layer disposed on the first low index layer, a first lens disposed on the first cap layer, and a first optically clear adhesive layer between the first low index layer and the first lens. The waveguide stack further includes a first anti-reflective coating layer between a top surface of a waveguide substrate and the first low index layer.

In yet another embodiment, a method of forming a waveguide is provided. The method includes dispensing a liquid optically clear adhesive layer on a lens, placing a waveguide stack including a first low index layer onto the liquid optically clear adhesive opposite the lens, and curing the liquid optically clear adhesive. The waveguide stack further includes a first cap layer disposed on the first low index layer.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of scope, and the present disclosure may admit to other equally effective embodiments.

FIG. 1 is a front view of a waveguide, according to certain embodiments.

FIG. 2 illustrates a flow chart of a method for forming a waveguide, according to certain embodiments.

FIGS. 3A-3D illustrate a waveguide substrate undergoing the method of FIG. 2, according to certain embodiments.

FIG. 4 illustrates a flow chart of a method for forming a waveguide, according to certain embodiments.

FIGS. 5A-5C illustrate a waveguide substrate undergoing the method of FIG. 4, according to certain embodiments.

FIG. 6A illustrates a schematic, cross-sectional view of a waveguide, according to certain embodiments.

FIG. 6B illustrates a schematic, cross-sectional view of a waveguide, according to certain embodiments.

FIG. 6C illustrates a schematic, cross-sectional view of a waveguide, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to waveguide combiners. More specifically, the present disclosure relates to methods of forming waveguide combiners.

Waveguide combiners, used for augmented reality, may include a lens disposed on the outside surfaces for various purposes, such as to protect the waveguide combiner or as part of a prescription. The lens may be attached to the waveguide combiner using an adhesive around the edge of waveguide. This method, however, creates an air gap between waveguide and lens. Due to the low index of air, light is trapped inside the waveguide and propagates to a predetermined location. However, the air gap impacts the reliability of assembled lens.

Alternatively, direct bonding may be used to secure the lens to the waveguide combiner by using an adhesive layer that can improve the reliability of the assembly. This bonding method presents an issue for waveguide combiners that rely on total internal reflection (TIR). To function, these waveguide combiners require a difference of refractive index between the two materials at the interface of the waveguide combiner and the adhesive layer. A low index film may be used between the waveguide combiner and the adhesive to promote functionality of the waveguide combiner. The low index film should have a refractive index close to air, as this is ideal for TIR and important for the field of view of the waveguide combiner. The low index film should be thick enough to isolate any evanescent loss from waveguide to outside media, such as to the adhesive layer. However, a majority of low index films are made of porous films, which are not mechanically robust or liquid proof. When these porous low index films contact the adhesive layer, the adhesive material penetrates into the low index film, due to porosity of the low index film, and alters the performance of the low index film, affecting TIR within the waveguide combiner and impacting the overall performance of the device.

The present disclosure provides a method to laminate a low index coating to a lens, such as a cover lens or a prescription lens, including the choice of adhesive, the lamination process, and the manufacturing process to improve low index coating reliability and compatibility with adhesives. Additionally, the present disclosure provides a waveguide having a cap layer disposed between the waveguide and at least one lens.

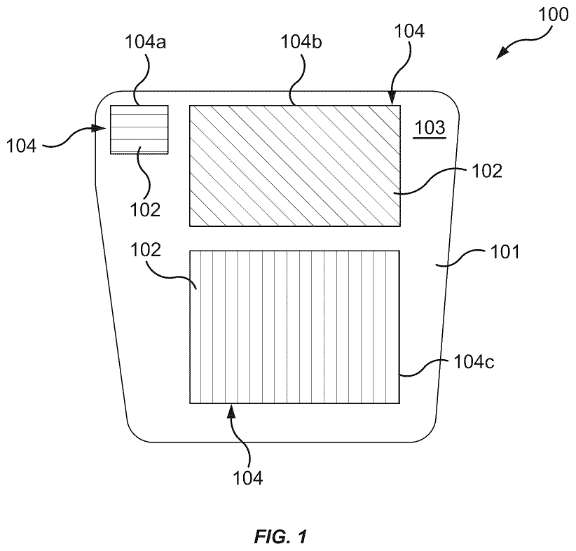

FIG. 1 is a front view of a waveguide 100, according to certain embodiments. It is to be understood that the waveguide 100 described herein is an exemplary waveguide and that other waveguides may be used with or modified to accomplish aspects of the present disclosure. The waveguide 100 includes a plurality of structures 102. The structures 102 may be disposed over, under, or on a surface 103 of a substrate 101, or disposed in the substrate 101. The structures 102 are nanostructures having a sub-micron critical dimension, e.g., a width less than 1 micrometer. Regions of the structures 102 correspond to one or more gratings 104. In one embodiment, which can be combined with other embodiments described herein, the waveguide 100 includes at least a first grating 104a corresponding to an input coupling grating and a third grating 104c corresponding to an output coupling grating. In another embodiment, which can be combined with other embodiments described herein, the waveguide 100 further includes a second grating 104b. The second grating 104b corresponds to a pupil expansion grating or a fold grating.

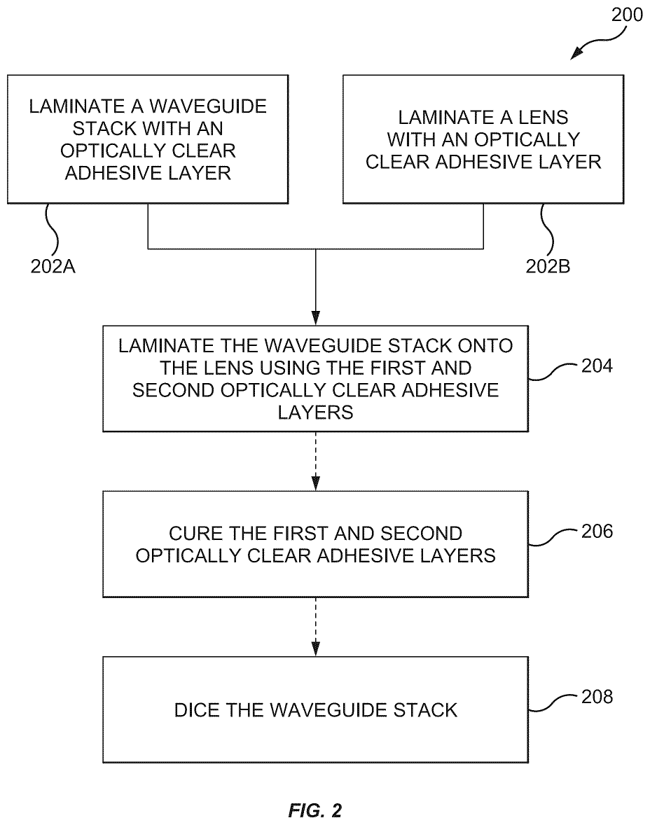

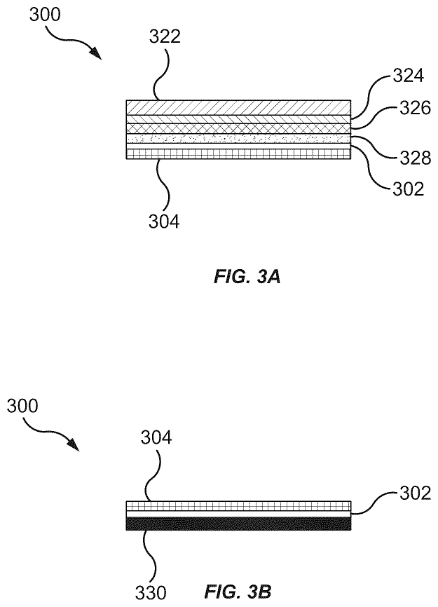

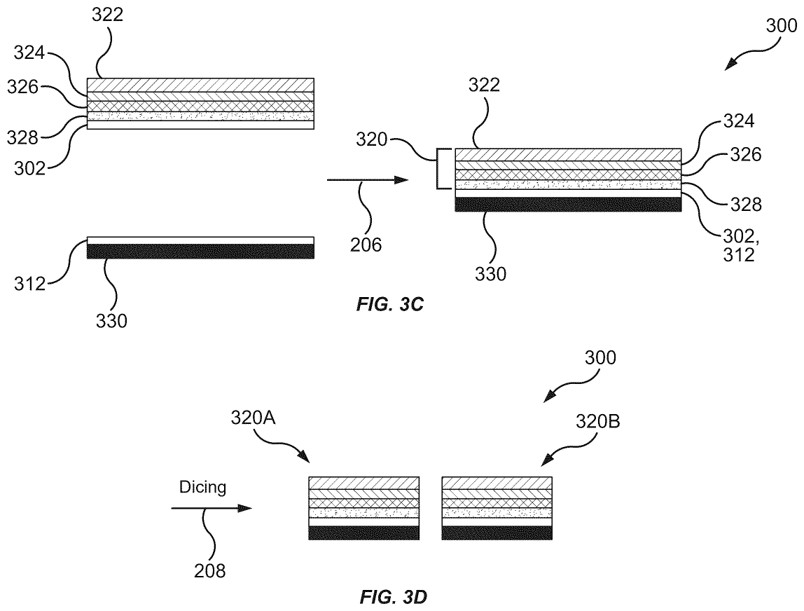

FIG. 2 illustrates a flow chart of a method 200 for forming a waveguide, according to certain embodiments. FIGS. 3A-3E illustrate a waveguide 300 undergoing the method of FIG. 2, according to certain embodiments.

The method 200 begins with either operation 202A or operation 202B. In operation 202A of method 200, a waveguide stack 320 is laminated with a first optically clear adhesive layer 302. The waveguide stack 320 includes a waveguide substrate 322, an anti-reflective coating layer 324, a low index layer 326, and a cap layer 328. The waveguide substrate 322 may be a diffractive waveguide that includes surface relief gratings, e.g., one or more gratings 104. The waveguide substrate 322 as a diffractive waveguide may be made of high index materials, such as high-index glass having a refractive index of about 1.7 to about 2.4, lithium niobate, silicon carbide (SiC), or Indium tin oxide (ITO). The waveguide substrate 322 may also include high index optical coatings deposited on the surface of the waveguide substrate 322, such as titanium oxide (TiO), niobium oxide (NbO), silicon nitride (SiN), tantalum oxide (TaO), silicon carbide (SiC), or a combination thereof.

Alternatively, the waveguide substrate 322 may be a reflective waveguide having reflection layers embedded within the waveguide substrate 322. The anti-reflective coating layer 324 is a coating with a thickness that decreases the reflectivity of the waveguide substrate 322 and may be made of anti-reflective materials, such as silicon dioxide (SiO₂), silicon nitrile (SiN), silicon oxynitride (SiON), titanium dioxide (TiO₂), niobium oxide (NbO), aluminum oxide (AlO), zirconium oxide (ZrO) or a combination thereof. For example, the anti-reflective coating layer 324 may include alternating layers of SiO₂ and TiO₂ or a single layer of SiO₂ having a thickness of about 100 nm. The low index layer 326 is made of porous materials having a refractive index of about 1.0 to about 1.4, such as porous silica or fluorinated polymers. For example, the low index layer 326 may be a porous silica layer having a refractive index of about 1.05 to about 1.25.

The cap layer 328 is a layer of a low index film and seals the porosity of the low index layer 326 from a subsequent adhesive layer such that the adhesive or other material does not leak into the porous film. The cap layer 328 then preserves the porosity and refractive index of the low index layer 326, ensuring consistent performance of the waveguide 300. The cap layer 328 may be made of suitable materials, such as silicon oxide (SiO), aluminum oxide (AlO), low density SiO made from the formation of an inorganic colloidal suspension and gelation of the suspension in a continuous liquid phase, or an organic coating. It can be deposited by spin coating, PVD, CVD or ALD. The film thickness of this cap layer is tuned to function as anti-reflective coating as well.

For lamination, a first liner (not shown) opposite the second liner 304 of the first optically clear adhesive layer 302 is removed, exposing a surface of the first optically clear adhesive layer 302. The exposed surface of the first optically clear adhesive layer 302 is then pressed onto or otherwise makes physical contact with the waveguide stack 320. After lamination, the first optically clear adhesive layer 302 is disposed on the cap layer 328 of the waveguide stack 320, as shown in FIG. 3A. Alternatively, the first optically clear adhesive layer 302 may be disposed on the low index layer 326 or any other layer of the waveguide stack 320. The first optically clear adhesive layer 302 includes a second liner 304 disposed opposite the waveguide stack 320. The first optically clear adhesive layer 302 may be made of any optically clear adhesive materials, such as acrylic-based adhesives or silicon-based adhesives.

Alternatively, in operation 202B, a lens 330 is laminated with the first optically clear adhesive layer 302 as shown in FIG. 3B following a lamination process similar to the lamination process in the operation 202A. The first optically clear adhesive layer 302 includes the second liner 304 disposed opposite the lens 330. The lens 330 may include prescription lens materials, such as urethane-based polymers, polycarbonates, or thiourethane resins, having a refractive index of about 1.45 to about 1.75, such as about 1.5 to about 1.7, and an abbe number of about 25 to about 65, such as about 31 to about 60. The lens 330 may also be a cover lens made of materials configured to protect the waveguide stack 320, such as polycarbonates, ultra-thin glass, aluminosilicate glass, or high ion-exchange aluminosilicate glass.

In operation 204, the second liner 304 is removed, depending on whether operation 202A or operation 202B occurred, and the waveguide stack 320 is laminated or otherwise placed onto the lens 330 as shown in FIG. 3C. When the waveguide stack 320 is laminated onto the lens 330, the first optically clear adhesive layer 302 or the second optically clear adhesive layer 312 contact the lens 330 or the waveguide stack 320, respectively. Optionally, the first optically clear adhesive layer 302, the second optically clear adhesive layer 312, or both may be cured in operation 206. Depending on the materials used for the first optically clear adhesive layer 302 or the second optically clear adhesive layer 312, curing, such as UV curing, may be required to solidify the first optically clear adhesive layer 302 and the second optically clear adhesive layer 312 to properly bond the waveguide stack 320 to the lens 330.

Optionally, the waveguide stack 320 and the lens 330 may be diced in operation 208 into a first section 320A and a second section 320B as shown in FIG. 3D. In some instances, the first optically clear adhesive layer 302 and the second optically clear adhesive layer 312, the waveguide stack 320, the lens 330 can be different size from each other. For example, the first optically clear adhesive layer 302 and the second optically clear adhesive layer 312 or the lens 330 can be a web-like sheet, the waveguide stack 320 can be a substrate, the lens 330 can be an injection-molded die-level part. For these scenarios, dicing processes (such as laser dicing) are completed at certain steps to facilitate the method 200 and create final parts. This laser dicing can be used for each layer, or can be used for laminated two layers or three layers. For example, laser dicing or die-cutting can be used to trim the first optically clear adhesive layer 302 and the second optically clear adhesive layer 312 to desired shape after operation 202 or operation 204. Laser dicing can be used to dice the laminated layers into die-shape as final parts.

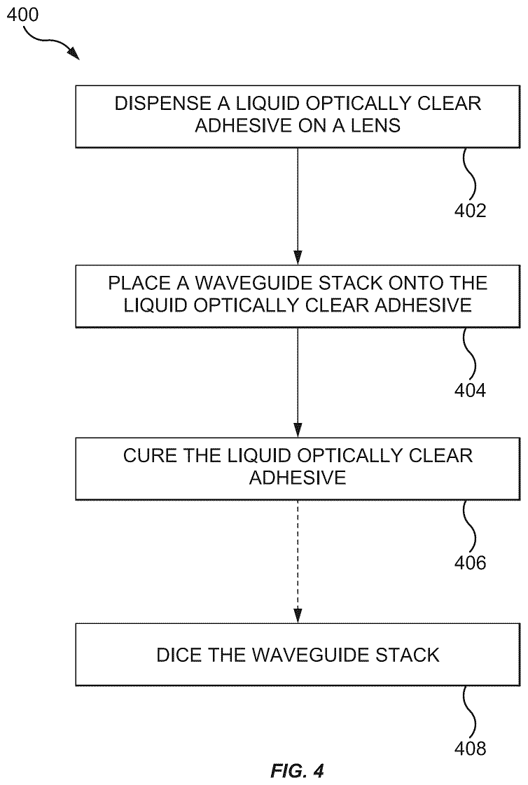

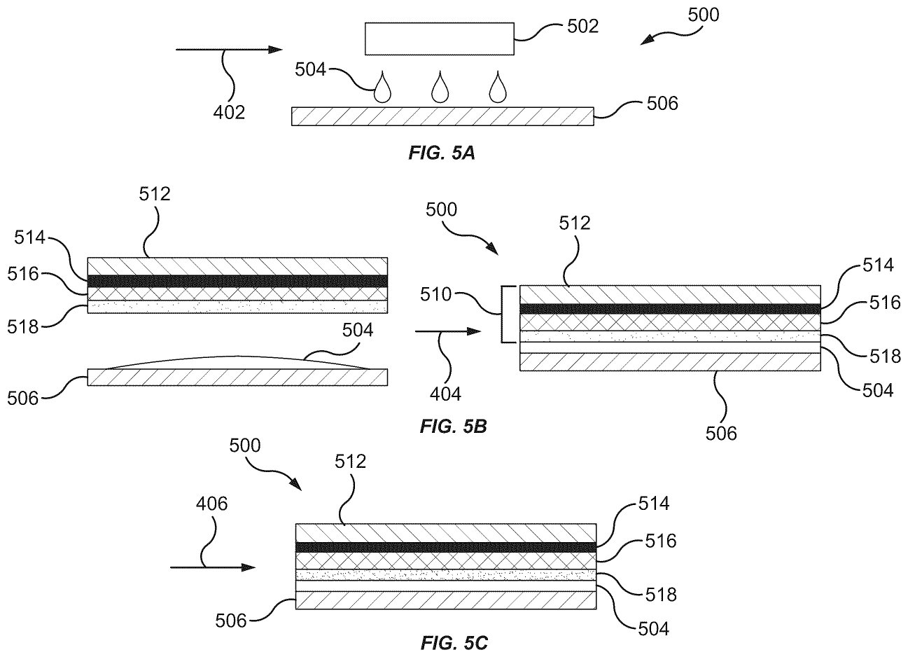

FIG. 4 illustrates a flow chart of a method 400 for forming a waveguide, according to certain embodiments. FIGS. 5A-5C illustrate a waveguide 500 undergoing the method of FIG. 4, according to certain embodiments.

In operation 402 of method 400, a liquid optically clear adhesive dispenser 502 is used to dispense or otherwise deposit a liquid optically clear adhesive 504 on a surface of a lens 506, as shown in FIG. 5A. The liquid optically clear adhesive 504 is an optically clear resin or optically clear adhesive that is in a liquid form. The liquid optically clear adhesive 504 penetrates into the pores of the layer beneath it. As such, in embodiments using the liquid optically clear adhesive dispenser 502 and the liquid optically clear adhesive 504, a cap layer 518 is required to be disposed between the liquid optically clear adhesive 504 and a low index layer 516 of a waveguide stack 510 to prevent the liquid optically clear adhesive 504 from penetrating and, ultimately, altering the performance of the low index layer 516 as shown in FIG. 5B. The lens 506 is shown to be flat or substantially flat. Alternatively, the lens 506 may be concave, convex, or a combination thereof. The lens 506 may be a prescription lens having materials, such as urethane-based polymers, polycarbonates, or thiourethane resins, having a refractive index of about 1.45 to about 1.75, such as about 1.5 to about 1.7, and an abbe number of about 25 to about 65, such as about 31 to about 60. The lens 506 may also be a cover lens made of materials configured to protect the waveguide stack 510, such as polycarbonates, ultra-thin glass, aluminosilicate glass, or high ion-exchange aluminosilicate glass. In embodiments where the lens 506 is a cover lens, the thickness of the lens may be about 0.2 um to about 2 mm and depends on the material used for the cover lens. For example, if a polycarbonate is used, the thickness may be about 50 μm to about 2 mm.

In operation 404, the waveguide stack 510 is placed on the liquid optically clear adhesive 504 opposite the lens 506 as shown in FIG. 5B. The waveguide stack 510 includes a waveguide substrate 512, an anti-reflective coating layer 514, the low index layer 516, and the cap layer 518. The waveguide stack 510 may be a diffractive waveguide that includes surface relief gratings, e.g., one or more gratings 104. The waveguide stack 510 as a diffractive waveguide may be made of high index materials, such as high-index glass having a refractive index of about 1.7 to about 2.4, lithium niobate, silicon carbide (SiC), or Indium tin oxide (ITO). The waveguide stack 510 may also include high index optical coatings deposited on the surface of the waveguide stack 510, such as titanium oxide (TiO), niobium oxide (NbO), silicon nitride (SiN), tantalum oxide (TaO), silicon carbide (SiC), or a combination thereof. Alternatively, the waveguide stack 510 may be a reflective waveguide having reflection layers embedded within the waveguide stack 510. The anti-reflective coating layer 514 is a coating with a thickness that decreases the reflectivity of the waveguide stack 510 and may be made of anti-reflective materials, such as silicon dioxide (SiO₂), silicon nitrile (SiN), silicon oxynitride (SiON), titanium dioxide (TiO₂), niobium oxide (NbO), aluminum oxide (AlO), zirconium oxide (ZrO), or a combination thereof. For example, the anti-reflective coating layer 514 may include alternating layers of SiO₂ and TiO₂ or a single layer of SiO₂ having a thickness of about 100 nm. The low index layer 516 is made of porous materials having a refractive index of about 1.0 and about 1.4, such as porous silica or fluorinated polymers. For example, the low index layer 516 may be a porous silica layer having a refractive index of about 1.10 to about 1.2. The cap layer 518 is a layer of a low index film and seals the porosity of the low index layer 516 from a subsequent adhesive layer such that the adhesive or other material does not leak into the porous film. The cap layer 518 then preserves the porosity and refractive index of the low index layer 516, ensuring consistent performance of the waveguide 300. The cap layer 518 may be made of suitable materials, such as silicon oxide (SiO), aluminum oxide (AlO), or an organic coating.

In operation 406, the liquid optically clear adhesive 504 is cured, such as by UV curing, to solidify the liquid optically clear adhesive 504 into an optically clear adhesive layer binding the waveguide stack 510 to the lens 506 as shown in FIG. 5C. In optional operation 408, the waveguide stack 510, the liquid optically clear adhesive 504, the lens 506, or a combination thereof may be diced similar to operation 208 of method 200, described above.

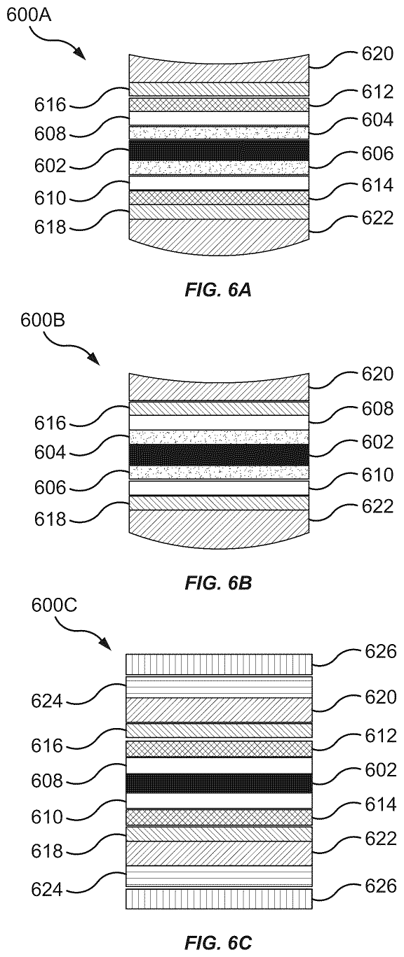

FIG. 6A illustrates a schematic, cross-sectional view of a waveguide stack 600A, according to certain embodiments. The waveguide stack 600A may be formed using either the method 200, the method 400, or a combination thereof.

As shown in FIG. 6A, the waveguide stack 600A includes a waveguide substrate 602 with a first anti-reflective coating layer 604 disposed on one side and a second anti-reflective coating layer 606 disposed on an opposing side. The first anti-reflective coating layer 604 has a first low index layer 608 disposed thereon. Similarly, the second anti-reflective coating layer 606 has a second low index layer 610 disposed thereon. The layer stack continues with a first cap layer 612 disposed on the first low index layer 608 and a second cap layer 614 disposed on the second low index layer 610. A first lens 620 is coupled to or bound to the first cap layer 612 by a first optically clear adhesive layer 616. The first lens 620 may be bound using either the method 200, the method 400, or a combination thereof. Similarly, a second lens 622 is coupled or bound to the second cap layer 614 by a second optically clear adhesive layer 618. The first lens 620 and the second lens 622 are shown to be concave and convex, respectively. Alternatively, the first lens 620 and the second lens 622 may be flat or substantially flat. The first lens 620, the second lens 622, or both may be prescription lenses having materials, such as urethane-based polymers, polycarbonates, or thiourethane resins, having a refractive index of about 1.45 to about 1.75, such as about 1.5 to about 1.7, and an abbe number of about 25 to about 65, such as about 31 to about 60. The first lens 620, the second lens 622, or both may also be a cover lens made of materials configured to protect the waveguide stack 320, such as polycarbonates, ultra-thin glass, aluminosilicate glass, or high ion-exchange aluminosilicate glass. In embodiments where the first lens 620, the second lens 622, or both are cover lenses, the thickness of each respective lens may be about 0.2 μm to about 2 mm and depends on the material used for the cover lens. For example, if a polycarbonate is used, the thickness may be about 50 μm to about 2 mm.

FIG. 6B illustrates a schematic, cross-sectional view of a waveguide stack 600B, according to certain embodiments. The waveguide stack 600A may be formed using either the method 200, the method 400, or a combination thereof.

As shown in FIG. 6B, the waveguide stack 600B includes a layer stack without the first cap layer 612 or the second cap layer 614. For example, the waveguide stack 600B includes the waveguide substrate 602, the first anti-reflective coating layer 604 and the second anti-reflective coating layer 606 disposed on either side of the waveguide substrate 602, the first low index layer 608 disposed on the first anti-reflective coating layer 604, and the second low index layer 610 disposed on the second anti-reflective coating layer 606. In this embodiment, the first lens 620 is coupled or bound to the first low index layer 608 directly by the first optically clear adhesive layer 616 and the second lens 622 is coupled or bound to the second low index layer 610 directly by the second optically clear adhesive layer 618. The first lens 620 and the second lens 622 are shown to be concave and convex, respectively. Alternatively, the first lens 620 and the second lens 622 may be flat or substantially flat. The first lens 620, the second lens 622, or both may be prescription lenses having materials, such as urethane-based polymers, polycarbonates, or thiourethane resins, having a refractive index of about 1.45 to about 1.75, such as about 1.5 to about 1.7, and an abbe number of about 25 to about 65, such as about 31 to about 60. The first lens 620, the second lens 622, or both may also be a cover lens made of materials configured to protect the waveguide stack 320, such as polycarbonates, ultra-thin glass, aluminosilicate glass, or high ion-exchange aluminosilicate glass. In embodiments where the first lens 620, the second lens 622, or both are cover lenses, the thickness of each respective lens may be about 0.2 μm to about 2 mm and depends on the material used for the cover lens. For example, if a polycarbonate is used, the thickness may be about 50 μm to about 2 mm.

FIG. 6C illustrates a schematic, cross-sectional view of a waveguide stack 600C, according to certain embodiments. The waveguide stack 600A may be formed using either the method 200, the method 400, or a combination thereof.

As shown in FIG. 6C, the waveguide stack 600C includes a layer stack similar to the layer stack of the waveguide stack 600A shown in FIG. 6A. The waveguide stack 600C includes the waveguide substrate 602, the first anti-reflective coating layer 604 and the second anti-reflective coating layer 606 disposed on either side of the waveguide substrate 602, the first low index layer 608 disposed on the first anti-reflective coating layer 604, the second low index layer 610 disposed on the second anti-reflective coating layer 606, the first cap layer 612 disposed on the first low index layer 608, and the second cap layer 614 disposed on the second low index layer 610. The first lens 620 is coupled or bound to the first cap layer 612 by the first optically clear adhesive layer 616 and the second lens 622 is coupled or bound to the second cap layer 614 by the second optically clear adhesive layer 618. In this embodiment, the first lens 620 and the second lens 622 are flat or substantially flat. Alternatively, the first lens 620, the second lens 622, or both may be concave, convex, or a combination thereof. The first lens 620, the second lens 622, or both may be prescription lenses having materials, such as urethane-based polymers, polycarbonates, or thiourethane resins, having a refractive index of about 1.45 to about 1.75, such as about 1.5 to about 1.7, and an abbe number of about 25 to about 65, such as about 31 to about 60. The first lens 620, the second lens 622, or both may also be a cover lens made of materials configured to protect the waveguide stack 320, such as polycarbonates, ultra-thin glass, aluminosilicate glass, or high ion-exchange aluminosilicate glass. In embodiments where the first lens 620, the second lens 622, or both are cover lenses, the thickness of each respective lens may be about 0.2 μm to about 2 mm and depends on the material used for the cover lens. For example, if a polycarbonate is used, the thickness may be about 50 μm to about 2 mm.

The first lens 620, the second lens 622, or both may also include one or more protective coatings, e.g., a first protective coating layer 624 and a second protective coating layer 626, disposed opposite the optically clear adhesive layer, e.g., the first optically clear adhesive layer 616 or the second optically clear adhesive layer 618. The first protective coating layer 624, the second protective coating layer 626, or both may be protective coatings, such as anti-scratch coatings, anti-glare coatings, anti-reflection coatings, ultraviolet protection coatings, photochromatic coatings, and blue-light reduction coatings. In embodiments where there are more than one protective coating, as shown in FIG. 6C, the protective coating layers need not be the same, e.g., the first protective coating layer 624 is an anti-reflection coating and the second protective coating layer 626 is an anti-scratch coating.

The present disclosure provides a waveguide and method of forming a waveguide that includes a cap layer disposed between an adhesive layer and a low index layer over a waveguide substrate. The cap layer prevents adhesive material from the adhesive layer from penetrating the low index layer, preserving the porosity of the low index layer. This allows for consistent, reliable performance of the low index layer in promoting total internal reflection within the waveguide substrate, improving the overall performance of the device.

When introducing elements of the present disclosure or exemplary aspects or embodiments thereof, the articles “a,” “an,” “the” and “said” are intended to mean that there are one or more of the elements.

The terms “comprising,” “including” and “having” are intended to be inclusive and mean that there may be additional elements other than the listed elements.

The term “coupled” is used herein to refer to the direct or indirect coupling between two objects. For example, if object A physically touches object B and object B touches object C, the objects A and C may still be considered coupled to one another—even if objects A and C do not directly physically touch each other. For instance, a first object may be coupled to a second object even though the first object is never directly in physical contact with the second object.

While the foregoing is directed to embodiments of the present disclosure, other and further embodiments of the disclosure may be devised without departing from the basic scope thereof, and the scope thereof is determined by the claims that follow.

What is claimed is:

1. A waveguide, comprising:
a waveguide stack including a waveguide substrate having a top surface and a bottom surface;
a first low index layer disposed on the top surface;
a first cap layer disposed on the first low index layer;
a first lens disposed on the first cap layer; and
a first optically clear adhesive layer between the first low index layer and the first lens.

2. The waveguide of claim 1, further comprising a first anti-reflective coating layer between the top surface and the first low index layer.

3. The waveguide of claim 1, wherein the first optically clear adhesive layer is formed by curing a liquid optically clear adhesive.

4. The waveguide of claim 1, further comprising a protective coating layer disposed on the lens opposite the low index layer.

5. The waveguide of claim 1, wherein the first low index layer comprises a refractive index of about 1 and about 1.3.

6. The waveguide of claim 1, wherein the first cap layer is configured to seal a porosity of the first low index layer.

7. The waveguide of claim 1, further comprising a second low index layer disposed on the bottom surface and a second lens disposed on the second low index layer.

8. A method of forming a waveguide, comprising:
laminating a waveguide stack comprising a first low index layer with a first optically clear adhesive layer; and
laminating the waveguide stack onto a lens using the first optically clear adhesive layer.

9. The method of claim 8, wherein the waveguide stack further comprises a first anti-reflective coating layer between a top surface of a waveguide substrate and the first low index layer.

10. The method of claim 8, wherein the waveguide stack further comprises a first cap layer disposed between the first low index layer and the first optically clear adhesive layer.

11. The method of claim 8, wherein a protective coating layer is disposed on the lens opposite the low index layer.

12. The method of claim 8, further comprising curing the first optically clear adhesive layer.

13. The method of claim 8, further comprising dicing the waveguide stack after laminating the waveguide stack onto the lens.

14. The method of claim 8, wherein the first low index layer comprises a refractive index of about 1 and about 1.3.

15. A method of forming a waveguide, comprising:
dispensing a liquid optically clear adhesive layer on a lens;
placing a waveguide stack comprising a first low index layer onto the liquid optically clear adhesive opposite the lens; and
curing the liquid optically clear adhesive.

16. The method of claim 15, further comprising dicing the waveguide stack after curing the liquid optically clear adhesive.

17. The method of claim 15, wherein the waveguide stack further comprises a first anti-reflective coating layer between a top surface of a waveguide substrate and the first low index layer.

18. The method of claim 15, wherein the waveguide stack further comprises a first cap layer disposed on the first low index layer.

19. The method of claim 15, wherein a protective coating layer is disposed on the lens opposite the low index layer.

20. The method of claim 15, wherein the first low index layer comprises a refractive index of about 1 and about 1.3.
